(19) United States
(12) Patent Application Publication
(10) Pub. No.: US 2022/0208018 A1
(43) Pub. Date: Jun. 30, 2022

(54) ARTIFICIAL INTELLIGENCE FOR LEARNING PATH RECOMMENDATIONS

(71) Applicant: INTERNATIONAL BUSINESS MACHINES CORPORATION, Armonk, NY (US)

(72) Inventors: Yasaman Khazaeni, Needham, MA (US); Elizabeth Daly, Dublin (IE); Christian Muise, Somerville, MA (US); Mikhail Yurochkin, Cambridge, MA (US)

(21) Appl. No.: 17/139,003

(22) Filed: Dec. 31, 2020

(51) Int. Cl. G09B 7/00; G06N 5/02; G06F 16/901

(52) U.S. Cl. CPC G09B 7/00; G06F 16/901; G06N 5/02

(57) ABSTRACT

Providing electronic media content to a user. An educational path and content are recommended to a user based on a user's current knowledge level. A first data set in a data structure representing a knowledge base is identified. The first data set represents a current knowledge point of a user in the knowledge base. A target data point is identified, outside the first data set, in the data structure, the target data point representing a target knowledge point for the user in the knowledge base. A path is generated between the first data set and the target data point via one or more other data points in the data structure.

### BACKGROUND

Embodiments of the invention generally relate to artificial intelligence, and in particular to machine learning and data science with applications to learning path recommendations.

Professional and amateur content producers and content providers have been developing a growing body of educational resources. These resources are made available to users via browser access on the Internet or via software applications (desktop, mobile, or tablet apps). Enterprise employees, students, and individual learners—i.e., “users”—among others, can benefit greatly from computer systems that provide tailored content to their educational needs.

### SUMMARY

Embodiments of the invention provide computer implemented methods, computer program products, and computer systems that perform one or more of the following functions, according to embodiments of the invention. An embodiment identifies a first data set in a data structure representing a knowledge base, the first data set representing a current knowledge point of a user in the knowledge base. The embodiment identifies a target data point, outside the first data set, in the data structure, the target data point representing a target knowledge point for the user in the knowledge base. The embodiment generates a path between the first data set and the target data point via one or more other data points in the data structure.

An embodiment of the invention identifies the target data point is performed using a user selection of a data point of the data structure.

In an embodiment of the invention, the target data point represents a knowledge domain identifier.

In an embodiment of the invention, the target data point represents a natural language document.

In an embodiment of the invention, nodes of the data structure are associated with educational content.

In an embodiment of the invention, the educational content comprises text, audio, video, or a combination thereof.

An embodiment of the invention recommends an educational curriculum to the user based on the path generated.

An embodiment of the invention provides educational content to the user based on the path generated.

In an embodiment of the invention, generating a path is performed by generating embeddings of a user's knowledge, learning goal, and available learning material, or a combination thereof, using an embedding technique; and performing topic modelling on the learning goal.

An embodiment of the invention generates a path uses an embedding metric.

In an embodiment of the invention, generating a path comprises uses an approximate metric.

### BRIEF DESCRIPTION OF THE SEVERAL VIEWS OF THE DRAWINGS

FIG. 1 is a functional block diagram of a logical graph of a learning path, according to an embodiment of the invention.

FIG. 2 is a flowchart of a method, according to an embodiment of the invention.

FIG. 3 is a flowchart illustrating functional steps of a method 300 operable in computing environment 100 (FIG. 1), according to an embodiment of the invention.

### DETAILED DESCRIPTION

A technological challenge in providing tailored educational content to users is that a user often must engage in an extensive search exercise on various educational platforms and spend valuable and limited time to identify the right educational content; often via trial and error. Determining whether particular content is well-suited to the user's need is often possible only after the user has spent resources (time or money) to engage with the content. It is also not immediately clear what collection of content the user should access to reach the desired level of knowledge or proficiency.

Another technological challenge is that a user may not be qualified to benefit from a particular educational content, because, for example, the user is lacking understanding of more foundational knowledge that the particular content develops on. For example, consider a student user wishing to read a research paper from a new domain like cognitive science. Jumping in and reading the paper may not be the best course of action, because the paper may reference complex concepts with which the student is unfamiliar. Were the user to begin reading the paper without building a foundational skill or knowledge base, the time spent on the paper likely will be wasted and is unlikely to result in any appreciable level of increased knowledge.

Inventors of the present invention have recognized that a technological solution to these and other challenges is to provide computer methods, systems, and computer program products that represent, in machine-readable form, a user's current knowledge level and the user's available resources, and will identify learning pathways to help the user reach the goal of understanding a new area of knowledge.

The inventors' contribution is purely technical in that it solves a technological limitation: the need to engage with a computer on a trial-and-error basis to research and understand a new area of knowledge. Therefore, embodiments of the invention are directed to improving the manner in and the mechanism by which computer systems are used to learn a new area of knowledge.

Generally, embodiments of the invention receive as input a machine representation of a user's existing knowledge, a learning goal (such as a particular topic or a specific document; e.g., a research paper), and learning resources (learning materials), and generate as output a subset of learning materials and an order to study them to help the user achieve the learning goal.

Embodiments of the invention achieve this by obtaining discrete or continuous embedding of all inputs in some latent space using a natural language processing (NLP) technique, such as word2vec, doc2vec or in general item2vec methods along with using human created tags/labels and methods such as topic modeling and text summarization. According to one definition, word embedding refers to any of a set of language modeling and feature learning techniques in natural language processing where words or phrases from the vocabulary are mapped to vectors of real numbers.

Embodiments of the invention generate an optimal path to the learning goal from the user's initial knowledge embedding through learning materials with either an embedding metric or an approximate metric.

In the embedding metric approach, embodiments of the invention compute geodesics between a user's knowledge (represented as either centroid or closest point to the learning goal) and learning goal according to the Riemannian metric induced by an embedding process. The embodiments find the best set of learning materials to approximate the geodesics, subject to a maximum number of materials the user is willing to ingest or consume.

In the approximate metric approach, embodiments of the invention construct a logical graph among embedded inputs connecting points within a small Euclidean distance from each other. The embodiments find the shortest path through this logical graph from the user's knowledge to the learning goal, subject to a maximum number of materials the user is willing to ingest or consume.

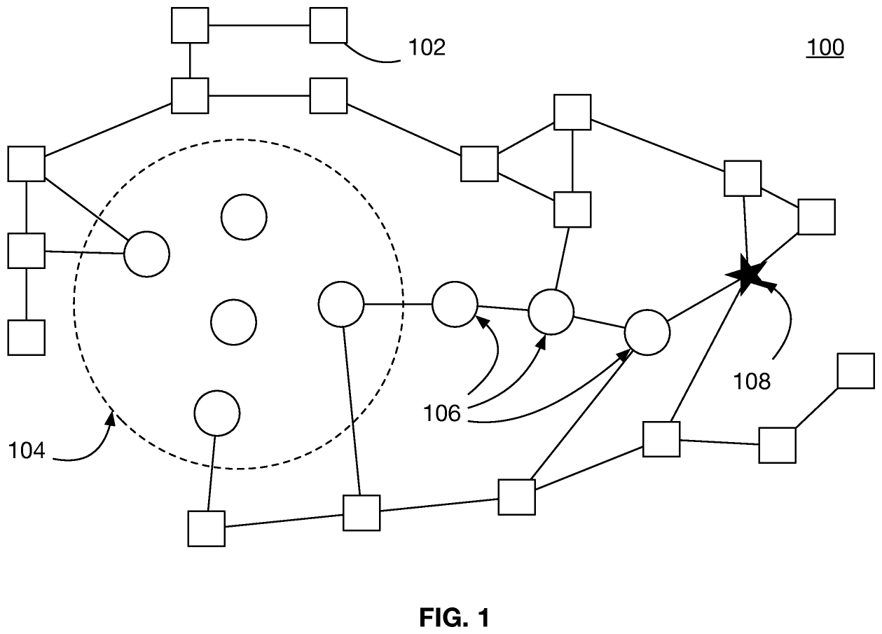

FIG. 1 is a functional block diagram of a logical graph 100 of a learning path 104, according to an embodiment of the invention. Logical graph 100 includes a set of nodes 102, a set of nodes 104, a set of nodes 106, and a set of nodes 108. Each node of logical graph 100 comprises a machine representation of knowledge, information, skill, certification, or educational material or content. Edges between two nodes may denote a relationship between two nodes, such as a hierarchy or dependency. Edges may be directional (including bidirectional). For example, in a given pair of connected nodes each of which represents a skill, node 1 may be a prerequisite for node 2; such that acquiring the skill of node 2 requires acquiring the skill of node 1.

In the depicted embodiment, node set 104, encircled by a dotted-line circle, represent a user's current knowledge, such as the user's current skills or currently consumed educational material.

In the depicted embodiment, node 108 represents a skill or content (such as an online course or a research paper) that the user wishes to understand. As is evident from the typography of logical graph 100, no node within node set 104 (the user's existing knowledge) connects directly to node 108. This indicates that the user can benefit from first consuming one or more intervening nodes, i.e., nodes of node set 106, before the user can effectively benefit from consuming material associated with node 108. For example, if node 108 represents knowledge conveyed by a cutting edge research paper in cognitive science, nodes in node set 106 may represent foundational knowledge in artificial intelligence, machine learning, data science, or the like; such that the user can better appreciate the information in the research paper by first consuming educational content associated with nodes of node set 106.

Accordingly, embodiments of the invention receive node set 104 as an input (or determine node set 104 via an assessment stage), identify a target node 108 as a learning goal, and determine an optimal path, i.e., node set 106, from node set 104 to node 108.

As can be appreciated from the typography of logical graph 100, there are multiple paths from nodes of node set 104 to node 108; however, node set 106 defines the shortest path. In the depicted example, “optimized” refers to the shortest path. However, in other embodiments, optimization may be defined via other metrics. For example, a user may benefit from acquiring additional knowledge that exists in a path to node 108 other than the shortest path; but which the user would like to reach to fulfil another goal. Other optimization parameters may be used as well.

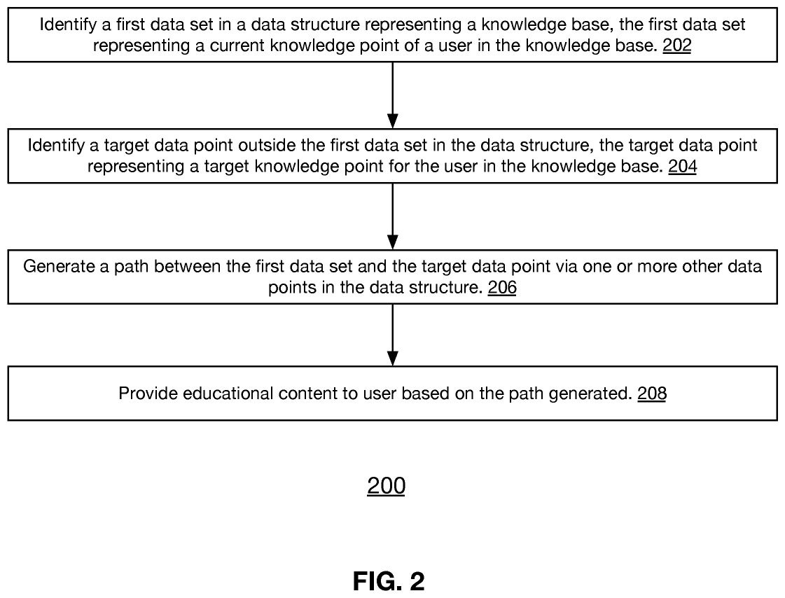

FIG. 2 is a flowchart of a method 200, according to an embodiment of the invention. Steps of method 200 are embodied as programming instructions for execution by one or more processors of one or more computing systems, and may be stored on tangible storage media or one or more computer program products.

Referring now to FIGS. 1 and 2, method 200 generally identifies (step 202) a first data set in a data structure representing a knowledge base, the first data set representing a current knowledge point of a user in the knowledge base. The data structure may be, for example, the data structure as represented by logical graph 100 of FIG. 1, including all or some of the nodes in the set of nodes 102, set of nodes 104, set of nodes 106, and set of nodes 108. The first data set may refer to the set of nodes 104.

Method 200 identifies (step 204) a target data point, for example data set 108, outside the first data set, for example data set 104, in the data structure. The target data point represents a target knowledge point for the user in the knowledge base.

Method 200 generates (step 206) a path between the first data set and the target data point via one or more other data points in the data structure. The one or more other data points may be, for example, data set 106.

In an embodiment, identifying the target data point is performed (not shown) using a user selection of a data point of the data structure. For example, a user may be presented an option, via a graphical user interface (GUI), to select a node in the logical graph 100. In an embodiment, the user may select an electronic representation of content or knowledge (such as a research paper, educational course, or topic), and method 200 may map the selection to a node in logical graph 100.

In an embodiment, the target data point represents a knowledge domain identifier. For example, a knowledge domain identifier may include areas of general knowledge such as science, medicine, art, history, and the like, or more specific areas of knowledge like computer science, cognitive science.

In an embodiment, the target data point represents a natural language document. For example, the natural language document may be a research paper that a user wishes to read and comprehend. Other nodes in the logical graph may represent educational content or other natural language documents that may assist the user in better understanding the research paper.

In an embodiment, nodes of the data structure are associated with educational content. The educational content may include electronic media content such as text, audio, video, or a combination thereof.

In an embodiment, method 200 recommends (not shown) an educational curriculum to the user based on the path generated. For example, a computer system includes a database storing educational content, each represented by a node in logical graph 100. Method 200 may group two or more nodes of logical graph 100 for recommendation to the user.

In an embodiment, method 200 provides (step 208) educational content to the user based on the path generated.

In an embodiment, generating a path is performed by generating embeddings of a user's knowledge, learning goal, and available learning material, or a combination thereof, using an embedding technique, and by performing topic modelling on the learning goal.

In an embodiment, method 200 generates a path using an embedding metric. Using an embedding metric may include computing geodesics between nodes representing a user's knowledge (represented as either centroid or closest point nodes to the learning goal node) and learning goal node according to the Riemannian metric, induced by the embedding procedure. Method 200 may find the best set of learning materials to approximate the geodesics subject to maximum number of materials the user is willing to ingest. Different methods may be employed to identify the “best” path; such as shortest distance, lowest cost, speed of access, or other metrics.

In an embodiment, method 200 generates a path using an approximate metric. Using an approximate metric may be performed by constructing a graph among embedded inputs connecting points of logical graph 100 within a small Euclidean distance from each other. Method 200 may find a shortest path through this graph from a user's knowledge to the learning goal subject to maximum number of materials the user is willing to ingest. Different methods may be employed to identify the “best” path; such as shortest distance, lowest cost, speed of access, or other metrics.

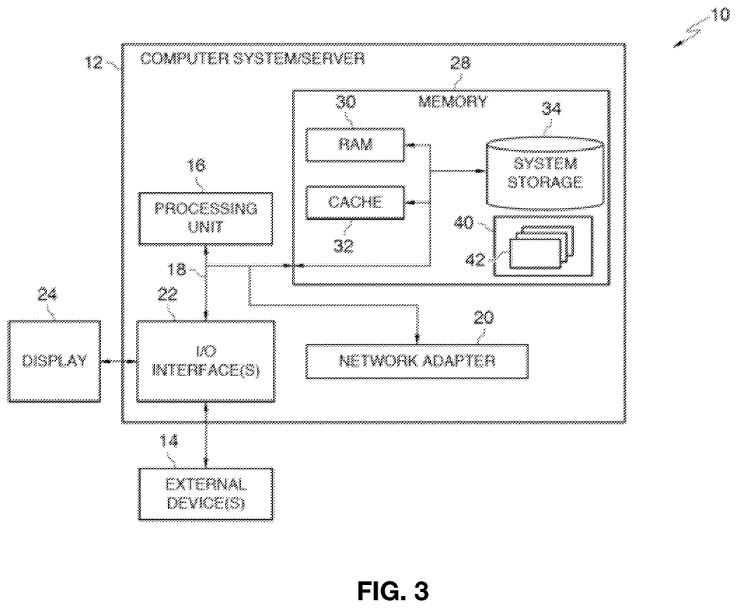

Referring now to FIG. 3, a schematic of an exemplary computing device (which may be a cloud computing node) is shown, according to an embodiment of the invention. Computing device 10 is only one example of a suitable cloud computing node and is not intended to suggest any limitation as to the scope of use or functionality of embodiments of the invention described herein.

In computing device 10, there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 3, computer system/server 12 in computing device 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

Referring now generally to embodiments of the present invention, the embodiments may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A method, comprising:
identifying a first data set in a data structure representing a knowledge base, the first data set representing a current knowledge point of a user in the knowledge base;
identifying a target data point, outside the first data set, in the data structure, the target data point representing a target knowledge point for the user in the knowledge base; and
generating a path between the first data set and the target data point via one or more other data points in the data structure.

2. The method of claim 1, wherein identifying the target data point is performed using a user selection of a data point of the data structure.

3. The method of claim 1, wherein the target data point represents a knowledge domain identifier.

4. The method of claim 1, wherein the target data point represents a natural language document.

5. The method of claim 1, wherein nodes of the data structure are associated with educational content.

6. The method of claim 5, wherein the educational content comprises text, audio, video, or a combination thereof.

7. The method of claim 1, further comprising:
recommending an educational curriculum to the user based on the path generated.

8. The method of claim 1, further comprising:
providing educational content to the user based on the path generated.

9. The method of claim 1, wherein generating a path comprises:
generating embeddings of a user's knowledge, learning goal, and available learning material, or a combination thereof, using an embedding technique; and
performing topic modelling on the learning goal.

10. The method of claim 1, wherein generating a path uses an embedding metric.

11. The method of claim 1, wherein generating a path comprises uses an approximate metric.

12. A computer program product for comprising one or more non-transitory tangible storage device having program code embodied therewith, the program code executable by one or more processors of one or more computers to perform a method, the method comprising:
identifying a first data set in a data structure representing a knowledge base, the first data set representing a current knowledge point of a user in the knowledge base;
identifying a target data point, outside the first data set, in the data structure, the target data point representing a target knowledge point for the user in the knowledge base; and
generating a path between the first data set and the target data point via one or more other data points in the data structure.

13. The computer program product of claim 12, wherein identifying the target data point is performed using a user selection of a data point of the data structure.

14. The computer program product of claim 12, wherein the target data point represents a knowledge domain identifier.

15. The computer program product of claim 12, wherein the target data point represents a natural language document.

16. The computer program product of claim 12, wherein nodes of the data structure are associated with educational content comprising comprises text, audio, video, or a combination thereof.

17. A computer system comprising:
one or more computer devices each having one or more processors and one or more tangible storage devices; and
a program embodied on at least one of the one or more storage devices, the program having a plurality of program instructions for execution by the one or more processors, the program instructions comprising instructions for:
identifying a first data set in a data structure representing a knowledge base, the first data set representing a current knowledge point of a user in the knowledge base;
identifying a target data point, outside the first data set, in the data structure, the target data point representing a target knowledge point for the user in the knowledge base; and
generating a path between the first data set and the target data point via one or more other data points in the data structure.

18. The computer system of claim 17, wherein identifying the target data point is performed using a user selection of a data point of the data structure.

19. The computer system of claim 17, wherein the target data point represents a knowledge domain identifier.

20. The computer system of claim 17, wherein the target data point represents a natural language document.
